(19) United States
(12) Patent Application Publication
(10) Pub. No.: US 2026/0205650 A1
(43) Pub. Date: Jul. 16, 2026

(54) METHOD AND DEVICE FOR INFORMATION PROCESSING

(71) Applicant: Beijing Zitiao Network Technology Co., Ltd., Beijing (CN)

(72) Inventors: Juan WANG, Beijing (CN); Bixing SHENG, Beijing (CN); Zepeng HAN, Beijing (CN); Zixuan WANG, Beijing (CN); Wei LIU, Beijing (CN); Decai LIU, Beijing (CN)

(21) Appl. No.: 19/139,265

(22) PCT Filed: Nov. 20, 2023
(86) PCT No.: PCT/CN2023/132582

§ 371 Date: Jun. 13, 2025

(30) Foreign Application Priority Data
Dec. 16, 2022 (CN) 202211628153.1

(51) Int. Cl. H04N 21/431; H04N 21/475; H04N 21/4788; H04N 21/488

(52) U.S. Cl. CPC H04N 21/4316; H04N 21/4753; H04N 21/4788; H04N 21/4884

(57) ABSTRACT

A method, a device and a medium for information processing, the method includes: receiving second page address information input into a first page, the second page address information being associated with multimedia content information; acquiring multimedia content information associated with a second page based on the second page address information; and displaying a multimedia display window in the first page and displaying the multimedia content information associated with the second page in the multimedia display window.

The present application claims priority to Chinese patent application No. 202211628153.1, filed on Dec. 16, 2022, entitled “METHOD AND DEVICE FOR INFORMATION PROCESSING”, which is hereby incorporated by reference in its entirety.

### FIELD

Embodiments of the present disclosure relate to the field of computer technology, and in particular, to a method and a device for information processing.

### BACKGROUND

Compared with text content and picture content, multimedia content has rich audio/video information. With the development of information transmission technology, multimedia information is widely used in various scenarios at present, for example, for recording live streaming processes and conference processes.

In some application scenarios, multimedia content may be stored in the cloud. In these application scenarios, multimedia content may be carried through a web page, and accordingly, an address of a multimedia content page may be input in an address bar of the web page, so as to jump to a page displaying the multimedia content.

### SUMMARY

Embodiments of the present disclosure provide a method and a device for information processing.

In a first aspect, an embodiment of the present disclosure provides a method for information processing, including: receiving second page address information input into a first page, where the second page address information is associated with multimedia content information; acquiring multimedia content information associated with a second page based on the second page address information; and displaying a multimedia display window in the first page and displaying the multimedia content information associated with the second page in the multimedia display window.

In a second aspect, an embodiment of the present disclosure provides a device for information processing, including: a receiving unit, configured to receive second page address information input into a first page, where the second page address information is associated with multimedia content information; an acquiring unit, configured to acquire multimedia content information associated with a second page based on the second page address information; and a displaying unit, configured to display a multimedia display window in the first page and display the multimedia content information associated with the second page in the multimedia display window.

In a third aspect, an embodiment of the present disclosure provides an electronic device, including: a processor and a memory, where the memory stores computer execution instructions; and the processor executes the computer execution instructions stored in the memory, so that the at least one processor performs the method for information processing according to the above first aspect and various possible methods for information processing of the first aspect.

In a fourth aspect, an embodiment of the present disclosure provides a computer-readable storage medium, where the computer-readable storage medium stores computer execution instructions, and when the computer execution instructions are executed by a processor, the method for information processing according to the above first aspect and various possible methods for information processing of the first aspect is implemented. In a fifth aspect, an embodiment of the present disclosure provides a computer program product, including a computer program, where when the computer program is executed by a processor, the method for information processing according to the above first aspect and various possible methods for information processing of the first aspect is implemented.

With the method and device for information processing provided in the embodiments, second page address information input into a first page is received, the second page address information is associated with multimedia content information; multimedia content information associated with a second page is acquired based on the second page address information; and a multimedia display window is displayed in the first page and the multimedia content information associated with the second page is displayed in the multimedia display window. The multimedia content information is acquired by inputting the address information of the second page associated with the multimedia content information in the first page, and the multimedia content information is displayed in the first page. Because the multimedia content information associated with the second address information may be displayed by inputting the second page address information in the first page, such that the first page may carry more information, which is beneficial to improve the efficiency of users acquiring information.

### BRIEF DESCRIPTION OF THE DRAWINGS

In order to more clearly illustrate the technical solutions in the embodiments of the present disclosure or in the prior art, the following will briefly introduce the drawings that need to be used in the description of the embodiments or the prior art. Obviously, the drawings in the following description are some embodiments of the present disclosure, and for those of ordinary skill in the art, other drawings may be obtained according to these drawings without creative labor.

FIG. 1 is a first schematic flowchart of a method for information processing provided by an embodiment of the present disclosure;

FIG. 2 is a second schematic flowchart of a method for information processing provided by an embodiment of the present disclosure;

FIGS. 3A-3B are schematic diagrams of an application scenario of a method for information processing provided by an embodiment of the present disclosure;

FIG. 4 is a structural block diagram of a device for information processing provided by an embodiment of the present disclosure; and

FIG. 5 is a schematic diagram of a hardware structure of an electronic device provided by an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and completely below with reference to the drawings in the embodiments of the present disclosure .. Obviously, the described embodiments are part of the embodiments of the present disclosure, but not all of the embodiments. Based on the embodiments in the present disclosure, all other embodiments obtained by those of ordinary skill in the art without creative labor belong to the protection scope of the present disclosure.

Multimedia content information is usually recorded on a page, and when a user wants to browse the multimedia content information, the user may input the address of the page in an address bar, so as to jump to the page, and display the multimedia content information in the page.

Generally, if a user wants to browse multimedia content while opening a current page (for example, an online document page), the user may switch the current page to the background, and open a multimedia page carrying the multimedia content information in the foreground through a web page address corresponding to the multimedia content. After browsing the multimedia page, the user switches the current page to the foreground again, and continues to operate the current page.

In the above process, in order to browse the multimedia content information, the user needs to perform switching operations between different pages. On the one hand, the above operations are cumbersome and bring inconvenience to the user. In addition, in the current technology, the content in two pages may not be obtained at the same time.

In order to solve the above problems, the method for information processing is provided in the present disclosure. The second page address information associated with multimedia content information is input in a first page, the multimedia content information is acquired based on the above address information, and the multimedia content information associated with a second page is displayed in the first page, thereby simplifying switching operations performed by the user between the first page and a page of the multimedia content information in order to browse the multimedia content information. In addition, since the multimedia content information associated with the second address information may be displayed by inputting the second page address information in the first page, the first page may carry more information, which is beneficial to improve the efficiency of the user acquiring information.

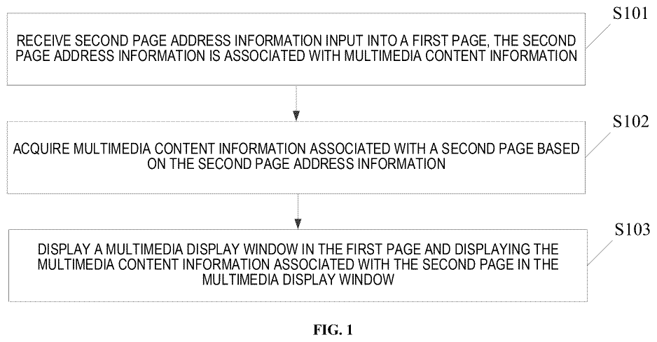

Please refer to FIG. 1, which shows a first schematic flowchart of a method for information processing provided by an embodiment of the present disclosure. As shown in FIG. 1, the method for information processing includes the followings.

At block S101, second page address information input into a first page is received. The second page address information is associated with multimedia content information.

The execution subject of the method for information processing in this embodiment may be a terminal device.

The first page here may be various editable pages, and illustratively, the first page may be a page of a cloud document that may be edited online; or it may be an instant messaging chat page.

When browsing or editing the first page, a user may input the second page address information into the first page. The second page address information may be, for example, a uniform resource locator (URL) link, an anchor text link, or other forms of address information such as a two-dimensional code.

The second page address information is associated with multimedia content information. For example, the resource at the second page address indicated by the second page address information includes the multimedia content information.

At block S102, multimedia content information associated with a second page is acquired based on the second page address information.

The second page address may be determined from the above second page address information, and the multimedia content information associated with the second page may be acquired from the above second page address.

In some application scenarios, the second page may be a page generated based on multimedia content recording. In these application scenarios, the second page may record other information in addition to the multimedia content information, such as recording details, recording-related controls, and so on.

In some other application scenarios, in the second page, the multimedia content information, a subtitle associated with the multimedia content information, and other information and/or controls other than the multimedia content information and the subtitle may be displayed.

At block S103, a multimedia display window is displayed in the first page and the multimedia content information associated with the second page is displayed in the multimedia display window.

After the multimedia content information is acquired, the multimedia display window may be displayed in the first page, and the multimedia content information may be displayed in the multimedia display window. Here, the display position of the multimedia display window displayed in the first page may be determined based on the input position of the second page address information in the first page, or may be determined based on other rules, which is not limited here.

In some embodiments, the above S103 include the followings.

A selection control is displayed, the selection control may be configured to select a display style of the second page address information, and the selection control includes a first control and a second control.

The first control here may be configured to indicate to display the multimedia content information associated with the second page address information in the form of the multimedia display window. The second control may be configured to indicate to display the multimedia content information associated with the second page address information in other feasible display styles, for example, call a local player to display the above multimedia content information in the form of a floating window.

In response to a selection operation on the first control, the multimedia content is displayed, in the first page, in the form of the multimedia display window.

In these embodiments, the selection control may be used to select to display, in the multimedia display window of the first page, the multimedia content information associated with the second page address information. It is beneficial for the user to set the display style of the multimedia content information according to his/her own preferences, which may improve the user experience.

In embodiments, second page address information input into a first page is received, the second page address information is associated with multimedia content information; multimedia content information associated with the second page is acquired based on the second page address information; and the multimedia display window is displayed in the first page and the multimedia content information associated with the second page is displayed in the multimedia display window. Thereby simplifying the switching operations performed by the user between the first page and the page of the multimedia content information in order to browse the multimedia content information. The information carrying capacity of the first page is improved, and the efficiency of the user acquiring information is improved.

In some embodiments, the above step S103 includes the following steps.

Firstly, a player is embedded into the first page.

Specifically, the player may be embedded into the first page based on the iframe technology. The above player may be configured to play the multimedia content information.

Then, the multimedia content information is displayed in an interface of the player, the multimedia content information includes at least partial multimedia information in the second page.

After the player is inserted into the first page, the player is run, the player interface is displayed, and the multimedia content information is displayed in the player interface.

The multimedia content information displayed in the above player interface may be part of the multimedia information in the above second page, or all of the multimedia information in the second page.

Compared with playing the multimedia content information in the first page with other playing technologies, by embedding the player into the first page and displaying the multimedia content information with the embedded player, it may be ensured that the multimedia content information is displayed more smoothly.

In some embodiments, the access permission of the first page and the access permission of the second page are independent of each other. A user who has permission to browse the first page may have no permission to access the second page. In these embodiments, since the access permission of the first page and the access permission of the second page are independent of each other, information security may be ensured to a certain extent.

In some embodiments, the above step S102 includes the following steps.

Firstly, in response to receiving an instruction to display a target multimedia to a first user in the first page, authentication is performed on access permission of the first user for the second page.

Then, in response to a failure of the authentication of the first user, prompt information is displayed.

The first user here may be a user who logs into the first page. The first user browses the multimedia content information associated with the second page address information by inputting the second page address information into the first page. Before acquiring the above multimedia content information, it is necessary to first authenticate whether the first user has access permission to the second page. If the authentication is passed, the multimedia content information is directly acquired and displayed to the first user. If the authentication fails, prompt information is displayed.

In some embodiments, the above step S102 includes the following steps.

Firstly, in response to the failure of the authentication of the first user, a permission request entry for acquiring the access permission of the second page is displayed.

Then, a permission request is sent according to a received predetermined operation performed on the permission request entry.

Finally, the multimedia content is acquired based on the acquired access permission of the second page.

If the authentication fails, it is necessary to apply for the access permission of the second page through the above permission request entry, and after obtaining the access permission of the second page, the multimedia content information corresponding to the second page may be acquired through the second page address information.

In these embodiments, through the above authentication process, information security may be protected on the one hand, and on the other hand, the user may be granted access to the multimedia content information based on his/her request, which is convenient for managing users who browse the target multimedia information.

In some embodiments, the above method for information processing further includes in response to receiving a first skip instruction of the multimedia content, skipping a multimedia segment without speech and/or including a predetermined type of speech or word when playing the multimedia content.

In practice, a content skip control for instructing to skip content may be displayed in the multimedia display window. When the user performs a trigger operation on the content skip control, it may be considered that the first skip instruction is received. In the above first page, the multimedia segment without speech and/or including a predetermined type of speech or word may be automatically skipped.

The multimedia segment without speech in the multimedia content or the segment including the predetermined type of speech or word may be skipped through the above content skip control. The predetermined type of speech here may be, for example, repetitive speech. The predetermined type of word here may be, for example, modal particles and other words.

In these embodiments, through the above first skip instruction, the multimedia segment without speech and/or including the predetermined type of speech or word may be skipped when the multimedia content is played, which is helpful for improving the efficiency of information acquisition when browsing the multimedia content.

In some embodiments, the above multimedia display window displays a page jump control, and the method for information processing further includes:
in response to receiving a trigger operation performed on the page jump control, jumping from the first page to the second page.

The above page jump control is configured to jump from the first page to the second page. The page jump control here may be a page jump control displayed, in the multimedia display window, in the process of displaying the multimedia information content.

In these embodiments, by providing the page jump control in the multimedia display window, the user may access the second page through the above page jump control, so as to browse the initial page of the multimedia content information and acquire more information related to the multimedia content information.

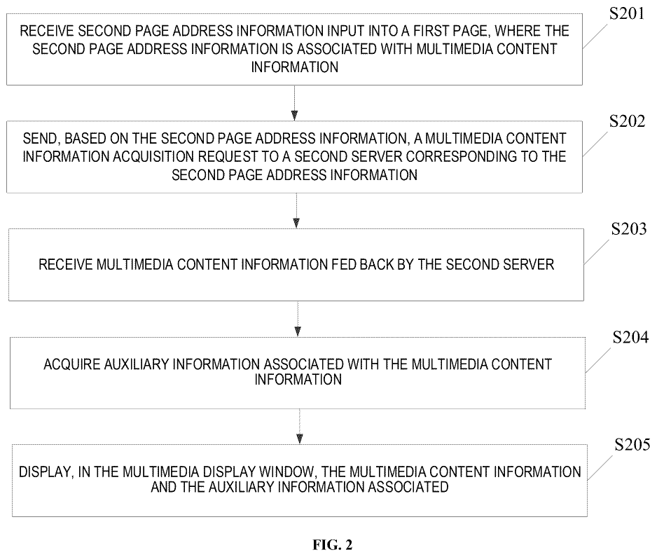

FIG. 2 is a second schematic flowchart of a method for information processing provided by an embodiment of the present disclosure. As shown in FIG. 2, the method for information processing includes the following steps.

At block S201, second page address information input into a first page is received, the second page address information is associated with multimedia content information.

The execution subject of this embodiment may be a terminal device.

For the specific implementation of step S201, reference may be made to step 101 of the embodiment shown in FIG. 1, which will not be repeated here.

At block S202, a multimedia content information acquisition request is sent to a second server corresponding to the second page address information based on the second page address information.

The second server here may be a server that provides resource services for the second page indicated by the second page address information.

The above execution subject may send the multimedia content information acquisition request to the above second server according to the above second page address information, for acquiring the multimedia content information associated with the second page address information. The above multimedia content information acquisition request may include the above second page address information.

At block S203, multimedia content information fed back by the second server is received.

After receiving the multimedia content information acquisition request, the second server may search for the multimedia content information associated with the second page address information according to the above second page address information, and send the searched multimedia content information to the above execution subject.

At block S204, auxiliary information associated with the multimedia content information is acquired.

The auxiliary information here may include a subtitle and/or other information.

In some application scenarios, the above second server stores the auxiliary information of the multimedia content information, or the second server has the capability to generate the auxiliary information according to the multimedia content information, and may send an information acquisition request to the second server to acquire the above auxiliary information. The second server may send the stored auxiliary information of the multimedia content information to the above execution subject according to the above information acquisition request, or generate the above auxiliary information according to the multimedia content information and send it to the above execution subject. In these application scenarios, the above S204 includes receiving the auxiliary information associated with the multimedia content information fed back by the second server.

In some other application scenarios, the above second server does not store the auxiliary information of the above multimedia content, or does not have the capability to generate the auxiliary information of the multimedia content information. The incapability here may include, for example, that the load of the second server exceeds a predetermined load threshold.

In these application scenarios, the above S204 includes acquiring, from a third server, the auxiliary information associated with the multimedia content information based on the second page address information or the multimedia content information. The third server is different from the second server.

As an implementation, the above execution subject may send the address information of the above second page to the third server, and the third server may acquire the multimedia content information from the second server according to the address information of the second page, and generate the above auxiliary information according to the multimedia content information. Then, the third server may send the generated auxiliary information to the above execution subject.

As another implementation, the above execution subject may send the multimedia content information to the third server after acquiring the multimedia content information from the second server. The third server may receive the above multimedia content information, generate auxiliary information according to the multimedia content information, and then send the above auxiliary information is sent to the above execution subject.

At block S205, the multimedia content information and the associated auxiliary information in the multimedia display window are displayed.

After acquiring the multimedia content information and the above auxiliary information, the multimedia content information and the auxiliary information corresponding to the multimedia content information may be displayed in the multimedia display window.

In some application scenarios, the auxiliary information includes subtitle information generated based on the multimedia content information, and the above S205 includes:
displaying, in the multimedia display window, the multimedia content and a subtitle corresponding to the multimedia content according to a received subtitle display instruction.

The subtitle display instruction here may be an instruction input in the form of voice, or may be an instruction conveyed based on a trigger operation on a related control, etc.

By using the subtitle display instruction to display the subtitle of the multimedia content information, it is beneficial for the user to set the display of the subtitle according to his/her own needs, which may improve the user experience.

As an implementation, the subtitle display instruction may be generated as follows. a subtitle switch control is displayed in the multimedia display window; and the subtitle display instruction is generated according to a received trigger operation on the subtitle switch control.

In this implementation, by setting the subtitle switch control in the multimedia display window, it is convenient for the user to control whether the subtitle is displayed, which may further improve the user experience.

In some embodiments, the above auxiliary information includes subtitle information generated based on the multimedia content information. The above S205 further includes:
displaying, in the multimedia display window, the multimedia content information and the subtitle corresponding to the multimedia content information in different regions.

The displaying the multimedia content information and the subtitle corresponding to the multimedia content information in different regions here may mean that there is at least partial nonoverlap between the region displaying the multimedia content information and the region displaying the above subtitle. In practice, there may be no overlap between the region displaying the multimedia content information and the region displaying the above subtitle.

In this way, by displaying the multimedia content information and the subtitle in different regions, it is beneficial to, when the multimedia content information is continuously played in its region, understand the context of the currently played multimedia content by moving the displayed subtitle content in the subtitle region through operations such as sliding, or quickly brows the overall content of the multimedia content information without watching the multimedia content information completely. It is helpful for the user to understand the multimedia content information.

In some embodiments, the method for information processing further includes the followings.

Firstly, a subtitle comment control is displayed in a subtitle display region.

Then, a comment interface is displayed based on a trigger operation performed on the subtitle comment control.

Finally, comment information input through the comment interface is received and displayed in the subtitle display region.

In these embodiments, by providing the subtitle comment control, it is convenient for the user to comment on the subtitle. If the user wants to comment on the target subtitle content in the subtitle, the user may trigger the above subtitle comment control. Then the comment interface is displayed, and the user may input the comment information into the comment interface. The input comment information may be displayed in the subtitle display region.

Specifically, the above comment information may be displayed in a blank space above, below, to the left, or to the right of the target subtitle content. On the one hand, the comment information may be recorded and displayed, and on the other hand, it is convenient for the user to search for the above comment information and the corresponding target subtitle content.

With the method for information processing provided in embodiments, second page address information input into a first page is received, the second page address information is associated with multimedia content information; a multimedia content information acquisition request is sent to a second server corresponding to the second page address information based on the second page address information; multimedia content information fed back by the second server is received; auxiliary information associated with the multimedia content information is acquired; and the multimedia content information and the associated auxiliary information are displayed in a multimedia display window. The multimedia content and the corresponding auxiliary information are displayed in the first page by inputting the second page address information in the first page, it is helpful for improving the efficiency of presenting the multimedia information and auxiliary information associated with the second page address information to the user, and the user experience may be improved.

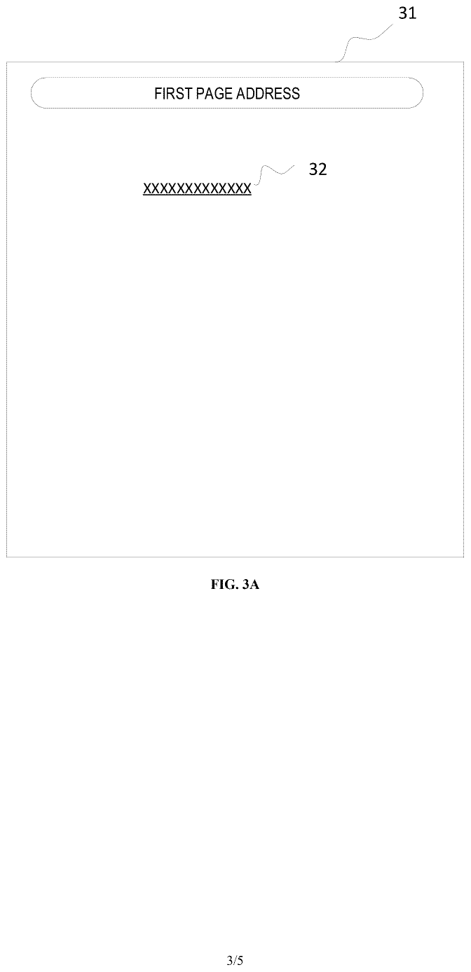

FIGS. 3A-3B show a schematic diagram of an application scenario of the present disclosure. As shown in FIG. 3A, a current user may open a first page 31 through a first page address, and input second page address information 32 into the first page 31. The second page address information 32 is associated with multimedia content information. After the current user inputs the second page address information 32, the multimedia content information associated with the second page address information may be acquired. As shown in FIG. 3B, a multimedia display window 33 may be displayed in the first page 31. The multimedia content information is displayed by the multimedia display window 33. In some embodiments, a player may be inserted into the multimedia display window, and the multimedia content information may be displayed in an interface 331 of the player. The interface 331 of the player further includes a playback progress bar 333 and a playback control 334. In some embodiments, auxiliary information of the multimedia content information may also be acquired and displayed in the multimedia display window. The above auxiliary information includes the subtitle. The multimedia content information and the subtitle may be displayed in different regions. As shown in FIG. 3B, the multimedia content information is displayed in a region 331 of the multimedia display window 33, and the subtitle corresponding to the multimedia content information is displayed in a region 332. The subtitle content corresponding to multiple segments of speech in the multimedia content information may be displayed in the region 332 in chronological order. For example, the subtitle content “YYYYYYYYYY” of the speech of the user A, the speech content “DDDDDDD” of the user B, and the subtitle content “EEEEEEEEEE” of the respective speech of the user C in FIG. 3B. Here, “YYYYYYYYYY”, “DDDDDDD”, and “EEEEEEEEEE” refer to any subtitle content respectively.

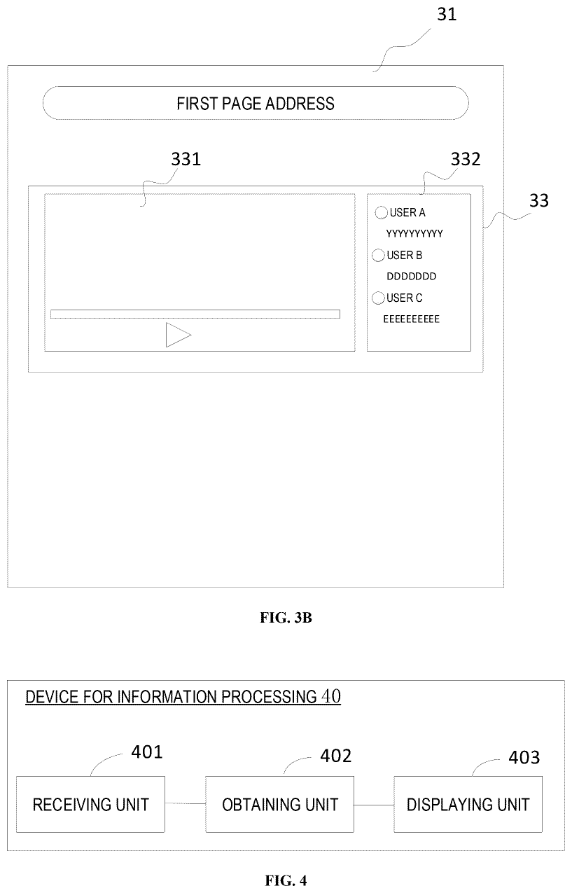

Corresponding to the method for information processing of the above embodiment, FIG. 4 is a structural block diagram of a device for information processing provided by an embodiment of the present disclosure. For the convenience of description, only parts related to the embodiments of the present disclosure are shown. Referring to FIG. 4, the device 40 includes: a receiving unit 401, an acquiring unit 402 and a displaying unit 403.

The receiving unit 401 is configured to receive second page address information input into a first page, where the second page address information is associated with multimedia content information.

The acquiring unit 402 is configured to acquire multimedia content information associated with a second page based on the second page address information.

The displaying unit 403 is configured to display a multimedia display window in the first page and display the multimedia content information associated with the second page in the multimedia display window.

In an embodiment of the present disclosure, the displaying unit 403 is further configured to:
embed a player into the first page; and
display the multimedia content information in an interface of the player, where the multimedia content information includes at least partial multimedia information in the second page.

In an embodiment of the present disclosure, the acquiring unit 402 is further configured to:
send, based on the second page address information, a multimedia content information acquisition request to a second server corresponding to the second page address information;
receive multimedia content information fed back by the second server; and
acquire auxiliary information associated with the multimedia content information. The display unit 403 is further configured to:
display, in the multimedia display window, the multimedia content information and the associated auxiliary information.

In an embodiment of the present disclosure, the acquiring unit 402 is further configured to:
receive the auxiliary information associated with the multimedia content information fed back by the second server.

In an embodiment of the present disclosure, the acquiring unit 402 is further configured to:
acquire, from a third server, the auxiliary information associated with the multimedia content information based on the second page address information or the multimedia content information.

The third server is different from the second server.

In an embodiment of the present disclosure, the auxiliary information includes subtitle information generated based on the multimedia content information.

In an embodiment of the present disclosure, the display unit 403 is further configured to:
display a selection control for selecting a display style of the second page address information, the selection control including a first control and a second control; and
in response to a selection operation on the first control, display, in the first page, the multimedia content in the form of the multimedia display window.

In an embodiment of the present disclosure, the auxiliary information includes subtitle information generated based on the multimedia content information; and the display unit 403 is further configured to:
display, in the multimedia display window, the multimedia content and a subtitle corresponding to the multimedia content according to a subtitle display instruction received.

In an embodiment of the present disclosure, the device 40 further includes a subtitle display instruction generation unit (not shown in the figure), and the subtitle display instruction generation unit generates the subtitle display instruction based on:
displaying, in the multimedia display window, a subtitle switch control; and
generating the subtitle display instruction according to a received trigger operation on the subtitle switch control.

In an embodiment of the present disclosure, the access permission of the first page and the access permission of the second page are independent of each other.

In an embodiment of the present disclosure, the acquiring unit 402 is further configured to:
in response to receiving an instruction to display a target multimedia to a first user in the first page, perform authentication on an access permission of the first user for the second page; and
in response to a failure of the authentication of the first user, display prompt information.

In an embodiment of the present disclosure, the acquiring unit 402 is further configured to:
in response to a failure of the authentication of the first user, display a permission request entry for acquiring the access permission of the second page;
send a permission request according to a received predetermined operation performed on the permission request entry; and
acquire the multimedia content based on the acquired access permission of the second page.

In an embodiment of the present disclosure, the auxiliary information includes subtitle information generated based on the multimedia content information. The display unit 403 is further configured to:
display, in the multimedia display window, the multimedia content information and the subtitle corresponding to the multimedia content information in different regions.

In an embodiment of the present disclosure, the device 40 further includes a comment unit (not shown in the figure), and the comment unit is configured to:
display a subtitle comment control in a subtitle display region;
display a comment interface based on a trigger operation performed on the subtitle comment control; and
receive comment information input through the comment interface and display the comment information in the subtitle display region.

In an embodiment of the present disclosure, the device 40 further includes a jump unit (not shown in the figure), and the jump unit is configured to:
in response to receiving a first skip instruction of the multimedia content, skip a multimedia segment without speech and/or including a predetermined type of speech or word when playing the multimedia content. I

n an embodiment of the present disclosure, the multimedia display window displays a page jump control, and the jump unit is further configured to:
in response to receiving a trigger operation performed on the page jump control, jump from the first page to the second page.

In an embodiment of the present disclosure, the second page is generated based on multimedia recording; and/or,
in the second page, the multimedia content information, a subtitle associated with the multimedia content information, and other information and/or controls other than the multimedia content information and the subtitle are displayed.

In order to implement the above embodiments, an embodiment of the present disclosure further provides an electronic device.

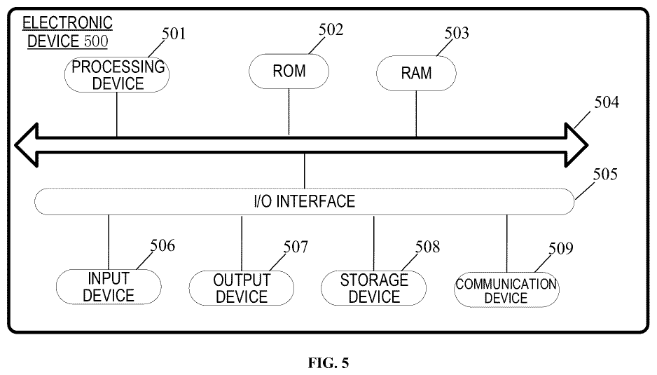

Referring to FIG. 5, it shows a schematic structural diagram of an electronic device suitable for implementing the embodiments of the present disclosure. The electronic device 500 may be an extended reality device, a terminal device or a server that provides services for the extended reality device. The terminal device may include, but is not limited to, mobile terminals such as a mobile phone, a notebook computer, a digital broadcast receiver, a personal digital assistant (PDA for short), a tablet computer, a portable media player (PMP for short), a vehicle-mounted terminal (such as a vehicle-mounted navigation terminal), etc., and a fixed terminal such as a digital TV, a desktop computer, etc. The electronic device shown in FIG. 5 is only an example, and should not bring any limitation to the function and scope of use of the embodiments of the present disclosure.

As shown in FIG. 5, the electronic device 500 may include a processing device (such as a central processing unit, a graphics processing unit, etc.) 501, which may perform various appropriate actions and processes according to a program stored in a read-only memory (abbreviated as ROM) 502 or a program loaded from a storage device 508 into a random-access memory (abbreviated as RAM) 503. In the RAM 503, various programs and data required for the operation of the electronic device 500 are also stored. The processing device 501, the ROM 502, and the RAM 503 are connected to each other through a bus 504. An input/output (I/O) interface 505 is also connected to the bus 504.

Generally, the following apparatus may be connected to the I/O interface 505: an input device 506 including, for example, a touchscreen, a touchpad, a keyboard, a mouse, a camera, a microphone, an accelerometer, a gyroscope, etc.; an output device 507 including, for example, a liquid crystal display (abbreviated as LCD), a speaker, a vibrator, etc.; a storage device 508 including, for example, a magnetic tape, a hard disk, etc.; and a communication device 509. The communication device 509 may allow the electronic device 500 to perform wireless or wired communication with other devices to exchange data. Although FIG. 5 shows an electronic device 500 having various apparatus, it should be understood that it is not required to implement or have all of the illustrated apparatus. More or fewer apparatus may alternatively be implemented or provided.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, and the computer program contains program codes for executing the methods shown in the flowcharts. In such an embodiment, the computer program may be downloaded and installed from a network through the communication device 509, or installed from the storage device 508, or installed from the ROM 502. When the computer program is executed by the processing device 501, the above functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program that may be used by or in combination with an instruction execution system, apparatus, or device. In the present disclosure, the computer-readable signal medium may include a data signal propagated in baseband or as part of a carrier wave, in which a computer-readable program code is carried. This propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by any suitable medium, including but not limited to: wire, optical cable, RF (radio frequency), etc., or any suitable combination thereof.

The above computer-readable medium may be included in the above electronic device, or may exist alone without being assembled into the electronic device.

The above computer-readable medium carries one or more programs, and when the one or more programs are executed by the electronic device, the electronic device is caused to execute the method shown in the above embodiments.

The computer program codes for executing the operations of the present disclosure may be written in one or more programming languages or a combination thereof. The above programming languages include object-oriented programming languages such as Java, Smalltalk, C++, and conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case of involving a remote computer, the remote computer may be connected to the user's computer through any kind of network, including a local area network (abbreviated as LAN) or a wide area network (abbreviated as WAN), or may be connected to an external computer (for example, using an Internet service provider to connect via the Internet).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of code, which includes one or more executable instructions for implementing a specified logical function. It should also be noted that, in some alternative implementations, the functions noted in the blocks may also occur out of the order noted in the drawings. For example, two blocks shown in succession may, in fact, may be executed substantially concurrently, or the blocks may sometimes be executed in a reverse order, depending upon the functionality involved. It should also be noted that each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented in software or hardware. Wherein, the name of the unit does not constitute a limitation on the unit itself under certain circumstances, for example, the receiving unit may also be described as “a unit for receiving second page address information input into a first page”.

The functions described herein above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and the like.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above descriptions are merely preferred embodiments of the present disclosure and illustrations of the applied technical principles. Those skilled in the art should understand that the scope of disclosure involved in the present disclosure is not limited to the technical solutions formed by the specific combination of the above technical features, and should also cover other technical solutions formed by the arbitrary combination of the above technical features or their equivalent features without departing from the above disclosed concept, for example, a technical solution formed by replacing the above features and technical features with similar functions disclosed in the present disclosure (but not limited to).

In addition, although operations are described in a particular order, this should not be understood as requiring that such operations be performed in the particular order shown or in sequential order. Under certain circumstances, multitasking and parallel processing may be advantageous. Likewise, although the above discussion contains several specific implementation details, these should not be construed as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the methods, it should be understood that the subject matter defined in the claims is not necessarily limited to the specific features or actions described above. Rather, the specific features and actions described above are merely exemplary forms for implementing the claims.

1. A method for information processing, comprising:
receiving second page address information input into a first page, the second page address information being associated with multimedia content information;
acquiring multimedia content information associated with a second page based on the second page address information; and
displaying a multimedia display window in the first page and displaying the multimedia content information associated with the second page in the multimedia display window.

2. The method according to claim 1, wherein displaying the multimedia display window in the first page and displaying the multimedia content information associated with the second page in the multimedia display window comprises:
embedding a player into the first page; and
displaying the multimedia content information in an interface of the player, the multimedia content information comprising at least partial multimedia information in the second page.

3. The method according to claim 1, wherein acquiring the multimedia content information associated with the second page based on the second page address information comprises:
sending, based on the second page address information, a multimedia content information acquisition request to a second server corresponding to the second page address information;
receiving multimedia content information fed back by the second server; and
acquiring auxiliary information associated with the multimedia content information; and
displaying the multimedia content information associated with the second page in the multimedia display window comprises:
displaying, in the multimedia display window, the multimedia content information and the auxiliary information associated.

4. The method according to claim 3, wherein acquiring the auxiliary information associated with the multimedia content information comprises:
receiving the auxiliary information associated with the multimedia content information fed back by the second server.

5. The method according to claim 3, wherein acquiring the auxiliary information associated with the multimedia content information comprises:
acquiring, from a third server, the auxiliary information associated with the multimedia content information based on the second page address information or the multimedia content information,
wherein the third server is different from the second server.

6. The method according to claim 3, wherein the auxiliary information comprises subtitle information generated based on the multimedia content information.

7. The method according to claim 1, wherein displaying the multimedia display window in the first page comprises:
displaying a selection control for selecting a display style of the second page address information, the selection control comprising a first control and a second control; and
in response to a selection operation on the first control, displaying, in the first page, the multimedia content in a form of the multimedia display window.

8. The method according to claim 3, wherein the auxiliary information comprises subtitle information generated based on the multimedia content information; and
displaying, in the multimedia display window, the multimedia content information and the associated auxiliary information comprises:
displaying, in the multimedia display window, the multimedia content and a subtitle corresponding to the multimedia content according to a subtitle display instruction received.

9. The method according to claim 8, wherein the subtitle display instruction is generated by:
displaying, in the multimedia display window, a subtitle switch control; and
generating the subtitle display instruction according to a received trigger operation on the subtitle switch control.

10. The method according to claim 1, wherein an access permission of the first page and an access permission of the second page are independent of each other.

11. The method according to claim 1, wherein acquiring the multimedia content information associated with the second page based on the second page address information comprises:
in response to receiving an instruction to display the multimedia content information to a first user in the first page, performing authentication on an access permission of the first user for the second page; and
in response to a failure of the authentication of the first user, displaying prompt information.

12. The method according to claim 11, wherein acquiring the multimedia content information associated with the second page based on the second page address information comprises:
in response to the failure of the authentication of the first user, displaying a permission request entry for acquiring the access permission of the second page;
sending a permission request according to a received predetermined operation performed on the permission request entry; and
acquiring the multimedia content based on the acquired access permission of the second page.

13. The method according to claim 3, wherein the auxiliary information comprises subtitle information generated based on the multimedia content information; and
displaying the multimedia content information and the associated auxiliary information in the multimedia display window comprises:
displaying, in the multimedia display window in different regions, the multimedia content information and a subtitle corresponding to the multimedia content information.

14. The method according to claim 13, further comprising:
displaying a subtitle comment control in a subtitle display region;
displaying a comment interface based on a trigger operation performed on the subtitle comment control; and
receiving comment information input through the comment interface and displaying the comment information in the subtitle display region.

15. The method according to claim 1, further comprising:
in response to receiving a first skip instruction of the multimedia content, skipping a multimedia segment without speech and/or comprising a predetermined type of speech or word when playing the multimedia content.

16. The method according to claim 1, wherein the multimedia display window displays a page jump control, and the method further comprises:
in response to receiving a trigger operation performed on the page jump control, jumping from the first page to the second page.

17. The method according to claim 1, wherein the second page is generated based on multimedia recording; and/or
in the second page, the multimedia content information, a subtitle associated with the multimedia content information, and other information and/or controls other than the multimedia content information and the subtitle are displayed.

18. (canceled)

19. An electronic device, comprising: a processor and a memory, wherein the memory stores computer execution instructions; and
the processor executes the computer execution instructions stored in the memory, causes the processor to execute operations comprising:
receiving second page address information input into a first page, the second page address information being associated with multimedia content information;
acquiring multimedia content information associated with a second page based on the second page address information; and
displaying a multimedia display window in the first page and displaying the multimedia content information associated with the second page in the multimedia display window.

20. A non-transitory computer-readable storage medium, storing computer execution instructions thereon, wherein the computer execution instructions, when executed by a processor, implement-the operations comprising:
receiving second page address information input into a first page, the second page address information being associated with multimedia content information;
acquiring multimedia content information associated with a second page based on the second page address information; and
displaying a multimedia display window in the first page and displaying the multimedia content information associated with the second page in the multimedia display window.

21. (canceled)
